(19) United States
(12) Patent Application Publication
(10) Pub. No.: US 2008/0033601 A1
(43) Pub. Date: Feb. 7, 2008

(54) Lawn sprinkler play apparatus

(75) Inventor: Thesdore G. Habing, Tustin, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Dream Visions, LLC

(21) Appl. No.: 11/498,394

(22) Filed: Aug. 1, 2006

(51) Int. Cl. G05D 7/00

(52) U.S. Cl. 700/284; 239/69

(57) ABSTRACT

A sprinkler play system has a central distribution station and a plurality of sprinkler stations. The sprinkler stations may be spaced apart on a lawn. The sprinkler stations are connected to the distribution station with flexible water conduits. Each of the sprinkler stations includes a low voltage solenoid valve. Electrical conductors may be included with the flexible water conduits in order to operate the solenoid valves. A control unit permits selective activation of the individual sprinkler stations.

### BACKGROUND OF THE INVENTION

1. Field of the Invention

This invention relates to the field of amusement devices and, more particularly, to a children's play apparatus having a plurality of remotely operated water sprinklers.

2. Background

Children enjoy water play, particularly in hot weather. It is a common sight to see children playing in and around lawn sprinklers during the summer months. Various devices that functionally resemble conventional lawn sprinklers have been designed specifically for amusement purposes. Examples of such devices can be seen in U.S. Pat. Nos. 5,480,336; 5,649,867; 5,820,472; 6,082,633 and 6,592,055. These devices have multiple spray heads or orifices, all of which spray at the same time. U.S. Pat. No. 5,683,314 shows a device with multiple spray heads in which the flow of water through a head may be turned on or off by the pressure of standing on the spray head. U.S. Pat. No. 4,982,959 shows a water sprinkler mat game with spray orifices placed at various locations on a mat defining a playing surface. U.S. Pat. No. 5,878,956 shows a motion activated water sprinkler that turns on for a period of time in response to the detection of movement. U.S. Pat. No. 5,918,809 shows a floating fountain display that moves to different position in the water and includes a valve system for spraying water through different nozzles.

### SUMMARY OF THE INVENTION

The present invention provides a sprinkler play apparatus that has a central distribution station and a plurality of sprinkler stations. The sprinkler stations may be spaced apart on a lawn. The sprinkler stations are connected to the distribution station with flexible water conduits. A control unit permits selective activation of the individual sprinkler stations.

The sprinkler stations may be electrically activated with low voltage solenoid valves, which may be located within each sprinkler station itself. Electrical conductors may be included with the flexible water conduits in order to operate the solenoid valves.

### BRIEF DESCRIPTION OF THE DRAWINGS

FIG. 1 illustrates a sprinkler play apparatus in accordance with an embodiment of the present invention.

FIG. 2 is a block diagram of the sprinkler play apparatus shown in FIG. 1.

FIG. 3 illustrates a sprinkler play apparatus in accordance with another embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

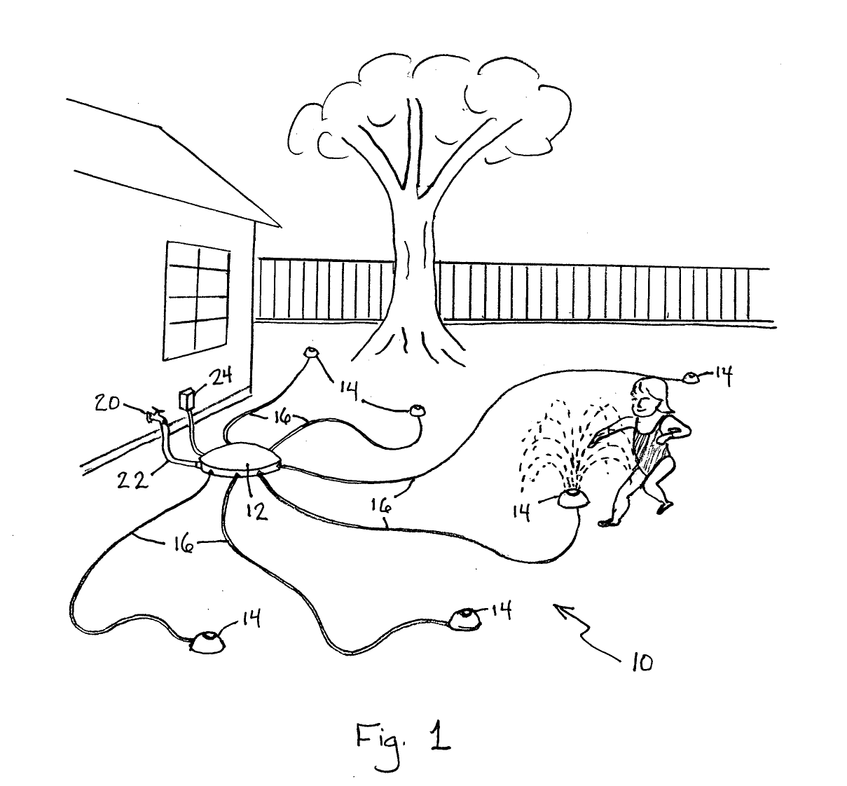

FIG. 1 provides an overview of a sprinkler play apparatus 10 in accordance with an embodiment of the present invention. The apparatus includes a central distribution station 12 and a plurality of sprinkler stations 14. The sprinkler stations are connected to the distribution station by flexible water conduits 16. It is preferred that each of the sprinkler stations include a solenoid-operated valve. Placing the valve within the sprinkler station itself maintains water pressure within the flexible conduit and thereby allows for a near instantaneous spray of water when the valve is activated. The solenoid may be energized by battery power within the sprinkler station itself or by means of electrical conductors connected to the distribution station. In this latter case, the conductors may be routed with or made an integral part of the flexible water conduits. The distribution station 12 is connected to a hose bib 20 by a length of garden hose 22. In embodiments where power for valve operation is supplied from the distribution station, the distribution station is coupled to a low voltage power supply 24.

The distribution station and each of the sprinkler stations may have a padded covering to reduce the possibility of injury in the event that a child falls on one of the stations. The covering may comprise, for example, vinyl padding of the type widely used for swimming pool floats. In addition, the distribution and sprinkler stations have a dome or cone-shaped outer configuration to provide for sufficient padding. The spray nozzles located in the sprinkler stations are preferably recessed below the upper surface to further reduce the possibility of injury in the event of a fall.

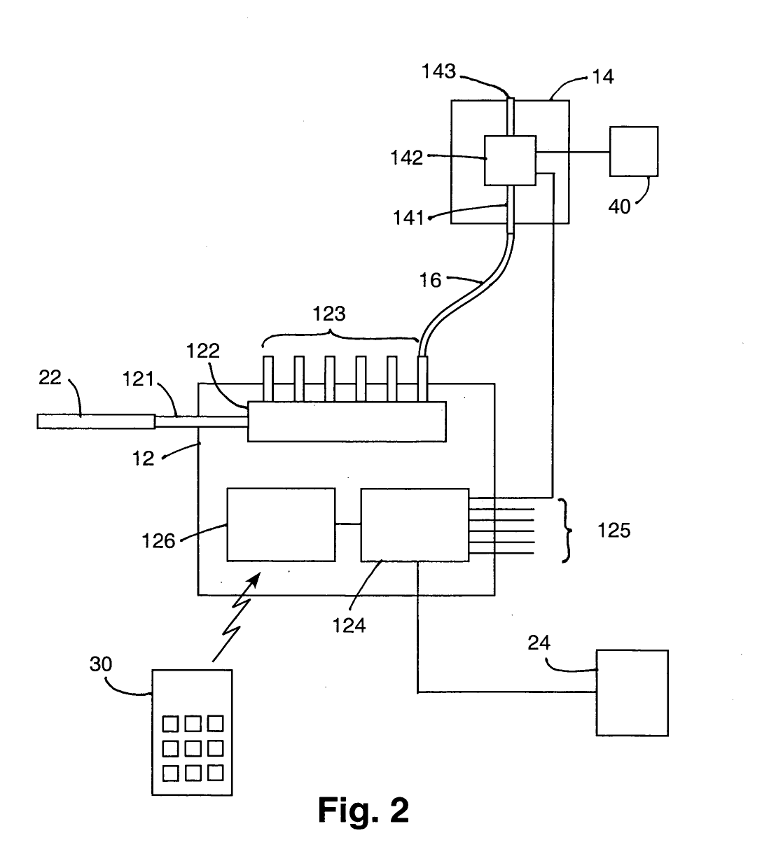

FIG. 2 is a functional block diagram of sprinkler play apparatus 10. Distribution station 12 has a water inlet 121 to which hose section 22 attaches. The water inlet 121 is in fluid communication with water manifold 122, which has a plurality of outlets 123. The flexible water conduits 16 connect to respective ones of the manifold outlets 123. In this embodiment, distribution station 12 receives electrical power from low voltage supply 24. The power is connected to sprinkler controller 124, which has a plurality of outputs 125 for controlling the individual sprinkler stations. Operation of the sprinkler stations may be manually controlled directly at the distribution station; however, it is desirable that the sprinkler stations be remotely controlled. For this purpose, distribution station 12 includes a remote control receiver module 126 for receiving commands from a portable remote control 30. Communications between the remote control unit 30 and receiver 126 may be via radio frequency (RF) or infrared (IR). Commands are appropriately decoded within receiver module 126 and delivered to controller 124.

Each of sprinkler stations 14 has a water inlet 141 to which a respective flexible water conduit 16 is coupled. Solenoid-operated valve 142 it is normally closed to prevent the discharge or water. When energized by a corresponding output 125, the solenoid-operated valve opens and allows water to be discharged through one or more spray nozzles or orifices 143. Different types of nozzles may be installed in different sprinkler stations to provide a variety of water spray patterns.

The remote control 30 is operated by a parent or one of the children to turn the individual sprinkler stations on and off. Children like to run from one sprinkler station to another as they are turned on. They also like to run around the different stations and guess which sprinkler station will be turned on next. The control unit may include a program that randomly turns the sprinkler stations on and off. The control unit may also include a timer circuit to limit the amount of time that any of the sprinkler stations may be left on.

The play apparatus may include a motion sensor 40 for one or more of the sprinkler stations. This allows the sprinkler station to be optionally activated in response to detected motion, such as a child approaching the station.

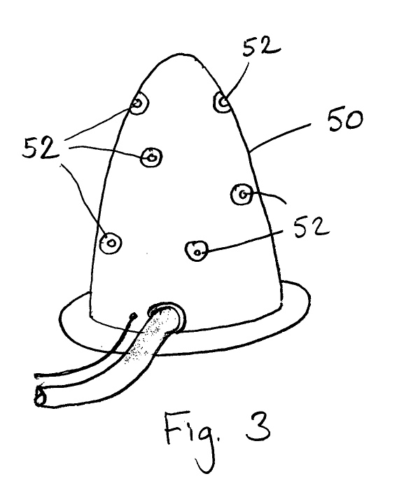

FIG. 3 shows a sprinkler spray apparatus 50 in accordance with an alternative embodiment of the invention. In this case, a plurality of spray nozzles 52 are located in a single cone-shaped housing. Here again, a remote control or random program is used to select which of the nozzles water will be sprayed from.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A sprinkler play apparatus comprising:
a distribution station with a water inlet configured to connect to a garden hose fitting and a plurality of water outlets;
a plurality of sprinkler stations connected to respective ones of the plurality of water outlets with flexible water conduits;
a control unit for selectively activating the plurality of sprinkler stations.

2. The sprinkler play apparatus of claim 1 wherein the sprinkler stations are electrically activated.

3. The sprinkler play apparatus of claim 2 wherein each sprinkler station includes an electrically operated valve.

4. The sprinkler play apparatus of claim 3 wherein the flexible water conduits include electrical conductors electrically connecting the valves to the distribution station.

5. The sprinkler play apparatus of claim 1 wherein the sprinkler stations are covered with a cushioning material.

6. The sprinkler play apparatus of claim 1 wherein at least two of the sprinkler stations have different spray patterns.

7. The sprinkler play apparatus of claim 1 wherein the control unit includes a timer for limiting activation of a sprinkler station to a predetermined period of time.

8. The sprinkler play apparatus of claim 1 further comprising a motion sensor.

9. The sprinkler play apparatus of claim 8 wherein a sprinkler station is activated in response to a signal from the motion sensor.

10. The sprinkler play apparatus of claim 8 wherein all sprinkler stations are deactivated if motion is not sensed for a predetermined period of time.

11. The sprinkler play apparatus of claim 1 wherein the control unit is remotely operated.

12. The sprinkler play apparatus of claim 1 wherein the control unit is operable to selectively activate each of the sprinkler stations.

13. The sprinkler play apparatus of claim 1 wherein the control unit includes means for activating the sprinkler stations in a random pattern.

14. The sprinkler play apparatus of claim 1 wherein the control unit controls a plurality of water valves, each of the water valves located proximate a respective one of the sprinkler stations.

15. A sprinkler play apparatus comprising:
a distribution station with a water inlet and a plurality of water outlets;
a plurality of sprinkler stations connected to respective ones of the water outlets with flexible water conduits, each of the sprinkler stations including a remotely controlled valve;
a control unit for selectively activating the valves.

16. The sprinkler play apparatus of claim 15 wherein the valves are electrically activated.

17. The sprinkler play apparatus of claim 15 wherein the flexible water conduits include electrical conductors electrically connecting the valves to the distribution station.

18. The sprinkler play apparatus of claim 15 wherein the sprinkler stations are covered with a cushioning material.

19. The sprinkler play apparatus of claim 15 wherein at least two of the sprinkler stations have different spray patterns.

20. The sprinkler play apparatus of claim 15 wherein the control unit includes a timer for limiting activation of a sprinkler station to a predetermined period of time.

21. The sprinkler play apparatus of claim 15 further comprising a motion sensor.

22. The sprinkler play apparatus of claim 21 wherein a sprinkler station is activated in response to a signal from the motion sensor.

23. The sprinkler play apparatus of claim 21 wherein all sprinkler stations are deactivated if motion is not sensed for a predetermined period of time.

24. The sprinkler play apparatus of claim 15 wherein the control unit is operable to selectively activate each of the sprinkler stations.

25. The sprinkler play apparatus of claim 15 wherein the control unit is remotely operated.

26. The sprinkler play apparatus of claim 25 wherein the control unit turns off all sprinkler stations when the control unit has not been remotely operated for a predetermined period of time.

27. The sprinkler play apparatus of claim 15 wherein the control unit includes means for activating the sprinkler stations in a random pattern.

28. The sprinkler play apparatus of claim 15 wherein the water inlet is configured to connect to a garden hose fitting.

29. A portable sprinkler play apparatus comprising:
a central dispersement hub;
a plurality of spray outlets arranged around the hub;
a water supply connection;
a valve system to supply water to one or more of the spray outlets at a time;
a remote control for controlling operation of the valve system.

30. The portable sprinkler play apparatus of claim 29 wherein the central dispersement hub is covered with a cushioning material.

31. The portable sprinkler play apparatus of claim 29 wherein each of the plurality of spray outlets is covered with a cushioning material.

32. The portable sprinkler play apparatus of claim 29 wherein the valve system comprises an electrically operated valve proximate to each of the spray outlets.

33. The portable sprinkler play apparatus of claim 32 wherein the spray outlets are positionable remote from the central dispersement hub.

34. The portable sprinkler play apparatus of claim 29 wherein at least two of the spray outlets have different spray patterns.

35. The portable sprinkler play apparatus of claim 29 further comprising means for turning off all of the spray outlets after any one of the spray outlet has continuously sprayed for a predetermined period of time.

36. The portable sprinkler play apparatus of claim 29 further comprising means for turning off all of the spray outlets after the remote control has not been operated for a predetermined period of time.

37. The portable sprinkler play apparatus of claim 29 further comprising a motion sensor.

38. The portable sprinkler play apparatus of claim 37 further comprising means for turning off all of the spray outlets if motion is not sensed for a predetermined period of time.
